(19) United States
(12) Patent Application Publication
(10) Pub. No.: US 2017/0203414 A1
(43) Pub. Date: Jul. 20, 2017

(54) Switching structure for pliers

(71) Applicant: Li-Tu Wu, Taichung City (TW)

(72) Inventor: Li-Tu Wu, Taichung City (TW)

(21) Appl. No.: 14/997,586

(22) Filed: Jan. 18, 2016

(51) Int. Cl. B25B 7/12

(52) U.S. Cl. CPC B25B 7/123

(57) ABSTRACT

A switching structure for pliers contains: a fixed clamp jaw, a movable clamp jaw, a first handle, a second handle, an actuation unit, and an adjustable threaded rod. The fixed clamp jaw is disposed on the first handle, the movable clamp jaw is rotatably connected with the fixed clamp jaw and the second handle. The actuation unit includes a spring, a driving post, a pushing post, and a switch element, the driving post has an arcuate section and a push portion. The switch element is rotatably coupled with one side surface of the driving post and pushes an inner surface of the second handle so as to limit a rotatable angle of the driving post and the second handle, the switch element has an arcuately convex face and a flat face which alternatively contact with the inner surface of the second handle.

### FIELD OF THE INVENTION

The present invention relates to a switching structure for pliers which switches the pliers to clamping mode or unclamping mode easily.

### BACKGROUND OF THE INVENTION

Conventional piles are adapted to cut steel cables, to twist metal tubes, to fix iron wires and handles, to remove nails and iron bolts, and to clamp workpieces.

A conventional adjustment structure of piles is disclosed in TW Patent No. M449066 and contains a fixed clamp jaw, a first handle, a first fixing portion connected with the first handle, a movable clamp jaw. The movable clamp jaw is connected with a second handle relative to the first handle and includes a second fixing portion corresponding to the fixing portion and rotatably connecting with the second handle and the fixed clamp jaw. The second fixing portion is driven by the second handle and moves relative to the first fixing portion. The conventional adjustment structure further comprises a locking unit which includes a limiting member rotatably coupling with the second handle and extending toward the first handle; and an adjustment unit including a threaded post screwing with the first handle and abutting against the limiting member of the locking unit, an adjusting button connecting with the threaded post, wherein the adjusting button has a control portion joining with the threaded post, and the control portion has an external face defined by an upper rim and a lower rim spaced from the upper rim. The control portion also has a recess defined between the upper rim and the lower rim.

However, as unclamping the workpiece, the locking unit is released by a release post, and the first handle and the second handle are pressed by a user intentionally to switch to a clamping mode again, thus switching the piles to an unclamping mode troublesomely.

The present invention has arisen to mitigate and/or obviate the afore-described disadvantages.

### SUMMARY OF THE INVENTION

The primary objective of the present invention is to provide a switching structure for pliers which switches the pliers to clamping mode or unclamping mode easily.

To obtain the above objective, a switching structure for pliers provided by the present invention contains: a fixed clamp jaw, a movable clamp jaw, a first handle, a second handle, an actuation unit, and an adjustable threaded rod.

The fixed clamp jaw is disposed on one end of the first handle, one end of an inner surface of the movable clamp jaw is rotatably connected with an inner surface of the fixed clamp jaw, and one end of an outer surface of the movable clamp jaw is rotatably coupled with the second handle, between the first handle and the second handle is defined a hollow space, the actuation unit includes a spring, a driving post, a pushing post, and a switch element, wherein a first end of the spring is mounted on an inner surface of the first handle, and a second end of the spring is fixed between two rotatable connecting portions of the movable clamp jaw, a first end of the driving post is rotatably connected with an inner surface of the second handle, and a second end of the driving post is inserted into the inner surface of the first handle, the driving post has an arcuate section on an outer periphery thereof, and the pushing post is rotatably joined with the inner surface of the second handle and its one end corresponds to and is forced by the arcuate section, the driving post has a push portion formed on the second end thereof, and the adjustable threaded rod is screwed into an outer surface of the second handle and its first end abuts against the push portion.

The switch element is rotatably coupled with one side surface of the driving post and pushes the inner surface of the second handle so as to limit a rotatable angle of the driving post and the second handle, the switch element has an arcuately convex face and a flat face which alternatively contact with the inner surface of the second handle.

When the arcuately convex face of the switch element contacts with the inner surface of the second handle, it limits the arcuate section so that the pushing post is not forced by the arcuate section.

When the flat face of the switch element contacts with the inner surface of the second handle, the arcuate section is not limited by the switch element and forces the pushing post.

### BRIEF DESCRIPTION OF THE DRAWINGS

FIG. 1 is a perspective view showing the exploded components of a switching structure for pliers according to a preferred embodiment of the present invention.

FIG. 2 is a perspective view showing the assembly of the switching structure for the pliers according to the preferred embodiment of the present invention.

FIG. 3 is a side plan view showing the operation of the switching structure for the pliers according to the preferred embodiment of the present invention.

FIG. 4 is another side plan view showing the operation of the switching structure for the pliers according to the preferred embodiment of the present invention.

### DETAILED DESCRIPTION OF THE PREFERRED EMBODIMENTS

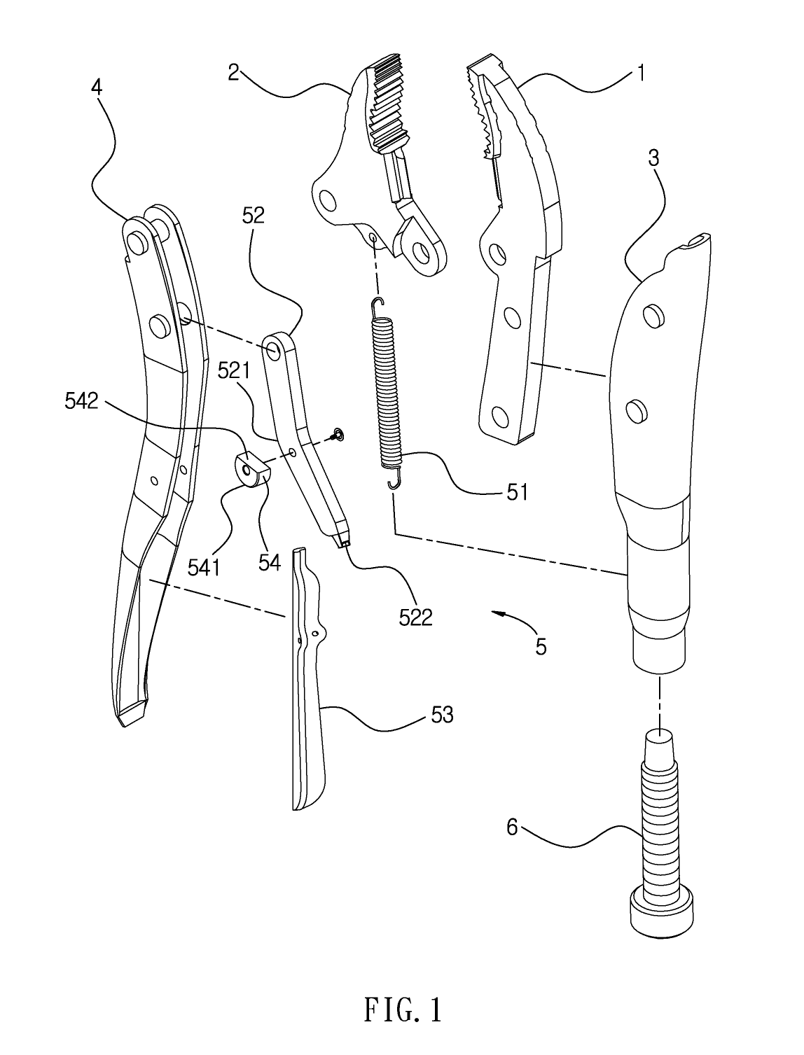

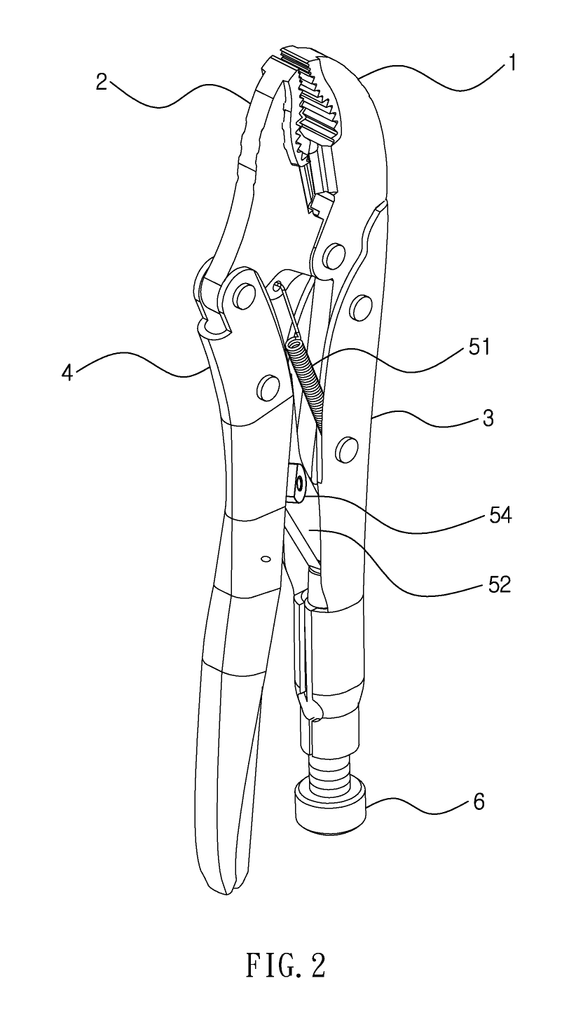

With reference to FIGS. 1 to 4, a switching structure for pliers according to a preferred embodiment of the present invention switches the pliers to clamping mode or unclamping mode easily. The switching structure comprises a fixed clamp jaw 1, a movable clamp jaw 2, a first handle 3, a second handle 4, an actuation unit 5, and an adjustable threaded rod 6.

The fixed clamp jaw 1 is disposed on one end of the first handle 3, one end of an inner surface of the movable clamp jaw 2 is rotatably connected with an inner surface of the fixed clamp jaw 1, and one end of an outer surface of the movable clamp jaw 2 is rotatably coupled with the second handle 4. Between the first handle 3 and the second handle 4 is defined a hollow space. The actuation unit 5 includes a spring 51, a driving post 52, a pushing post 53, and a switch element 54. A first end of the spring 51 is mounted on an inner surface of the first handle 3, and a second end of the spring 51 is fixed between two rotatable connecting portions of the movable clamp jaw 2. A first end of the driving post 52 is rotatably connected with an inner surface of the second handle 4, and a second end of the driving post 52 is inserted into the inner surface of the first handle 3. The driving post 52 has an arcuate section 521 formed on an outer periphery thereof, and the pushing post 53 is rotatably joined with the inner surface of the second handle 4 and its one end corresponds to and is forced by the arcuate section 521. The driving post 52 has a push portion 522 formed on the second end thereof, and the adjustable threaded rod 6 is screwed into an outer surface of the second handle 4 and its first end abuts against the push portion 522.

In operation, the actuation unit 5 controls a clamping distance between the fixed clamp jaw 1 and the movable clamp jaw 2, hence when the fixed clamp jaw 1 and the movable clamp jaw 2 clamp a workpiece, the fixed clamp jaw 1 forces the first handle 3, and the movable clamp jaw 2 presses the second handle 4, such that a rotatable connection portion of the driving post 52 and the second handle 4 offsets, and the one end of the switch element 54 is forced by the arcuate section 521.

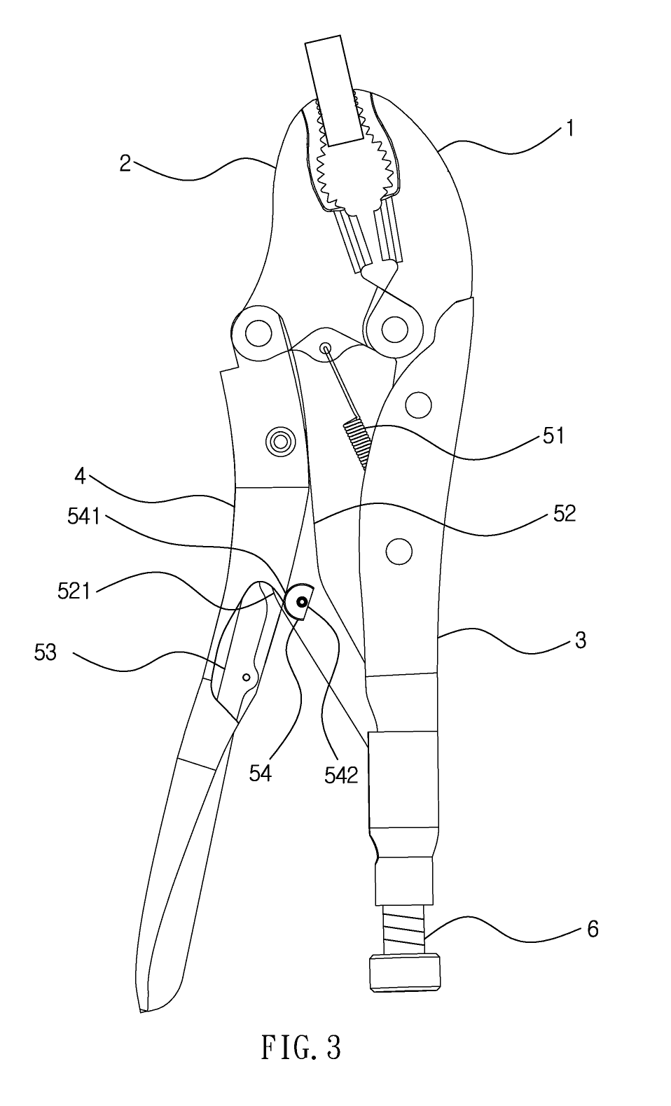

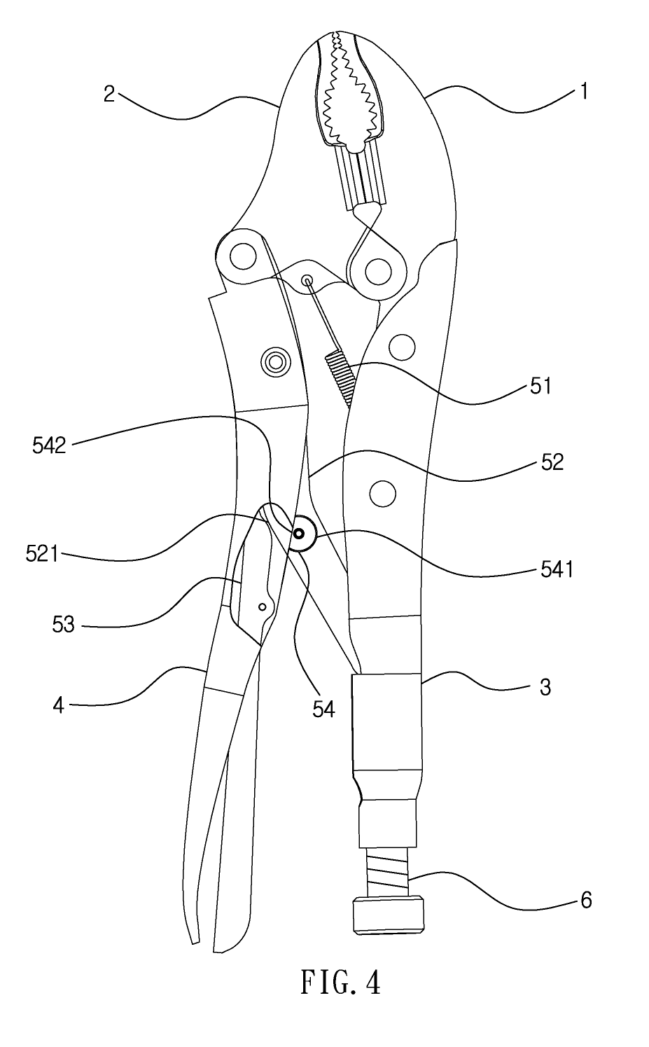

The switch element 54 is rotatably coupled with one side surface of the driving post 52 and pushes the inner surface of the second handle 4 so as to limit a rotatable angle of the driving post 52 and the second handle 4. The switch element 54 has an arcuately convex face 541 and a flat face 542 which alternatively contact with the inner surface of the second handle 4. For example, when the arcuately convex face 541 of the switch element 54 contacts with the inner surface of the second handle 4, it limits the arcuate section 521 so that the pushing post 53 is not forced by the arcuate section 521 (as shown in FIG. 3), hence the first handle 3 and the second handle 4 are not manually pressed by a user. When the flat face 542 of the switch element 54 contacts with the inner surface of the second handle 4, the arcuate section 521 is not limited by the switch element 54 and forces the pushing post 53 (as illustrated in FIG. 4), such that the first handle 3 and the second handle 4 are manually pressed by the user.

Thereby, the rotatable angle of the driving post 52 and the second handle 4 is controlled by the switch element 54, and the arcuate section 521 forces or does not force the pushing post 53 so that the first handle 3 and the second handle 4 can be manually pressed or cannot be manually pressed.

In other words, the arcuately convex face 541 of the switch element 54 contacts with the inner surface of the second handle 4 so as to stop the first handle 3 and the second handle 4 being manually pressed by the user. The flat face 542 of the switch element 54 contacts with the inner surface of the second handle 4 so that the first handle 3 and the second handle 4 is manually pressed by the user, thus clamping the workpiece.

While the preferred embodiments of the invention have been set fourth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A switching structure for pliers comprising: a fixed clamp jaw, a movable clamp jaw, a first handle, a second handle, an actuation unit, and an adjustable threaded rod; wherein
the fixed clamp jaw is disposed on one end of the first handle, one end of an inner surface of the movable clamp jaw is rotatably connected with an inner surface of the fixed clamp jaw, and one end of an outer surface of the movable clamp jaw is rotatably coupled with the second handle, between the first handle and the second handle is defined a hollow space, the actuation unit includes a spring, a driving post, a pushing post, and a switch element, wherein a first end of the spring is mounted on an inner surface of the first handle, and a second end of the spring is fixed between two rotatable connecting portions of the movable clamp jaw, a first end of the driving post is rotatably connected with an inner surface of the second handle, and a second end of the driving post is inserted into the inner surface of the first handle, the driving post has an arcuate section on an outer periphery thereof, and the pushing post is rotatably joined with the inner surface of the second handle and its one end corresponds to and is forced by the arcuate section, the driving post has a push portion formed on the second end thereof, and the adjustable threaded rod is screwed into an outer surface of the second handle and its first end abuts against the push portion;
the switch element is rotatably coupled with one side surface of the driving post and pushes the inner surface of the second handle so as to limit a rotatable angle of the driving post and the second handle, the switch element has an arcuately convex face and a flat face which alternatively contact with the inner surface of the second handle;
when the arcuately convex face of the switch element contacts with the inner surface of the second handle, it limits the arcuate section so that the pushing post is not forced by the arcuate section;
when the flat face of the switch element contacts with the inner surface of the second handle, the arcuate section is not limited by the switch element and forces the pushing post.
